(19) United States
(12) Patent Application Publication
(10) Pub. No.: US 2025/0201967 A1
(43) Pub. Date: Jun. 19, 2025

(54) EXPANSION TANK AND BATTERY COOLING SYSTEM

(71) Applicant: MAHLE International GmbH, Stuttgart (DE)

(72) Inventors: Birgit Dilger, Schwaikheim (DE); Hans-Martin Ruppert, Ostfildren (DE); Ralf Zink, Stuttgart (DE)

(21) Appl. No.: 18/979,566

(22) Filed: Dec. 12, 2024

(30) Foreign Application Priority Data
Dec. 15, 2023 (DE) 10 2023 135 287.3

(51) Int. Cl. H01M 10/6568; H01M 10/613

(52) U.S. Cl. CPC H01M 10/6568; H01M 10/613

(57) ABSTRACT

An expansion tank for a battery cooling system may include a tank housing having a first lid and a second lid, a dryer cartridge screwable onto a threaded nipple of the first lid, a vacuum valve arranged in the first lid, and a pressure relief valve arranged in the second lid. Fresh air from an environment may enter the expansion tank via the vacuum valve and the dryer cartridge when there is a vacuum in the expansion tank. Air may be released from the expansion tank into the environment via the pressure relief valve when there is excess pressure in the expansion tank.

### CROSS-REFERENCE TO RELATED APPLICATION

This application claims priority to German Patent Application No. DE 10 2023 135 287.3, filed on Dec. 15, 2023, the contents of which is hereby incorporated by reference in its entirety.

### TECHNICAL FIELD

The present invention relates to an expansion tank for a battery cooling system. The invention also relates to a battery cooling system with such an expansion tank.

### BACKGROUND

Electric or hybrid vehicles are increasingly becoming the focus of consumers due to environmental aspects and are therefore also becoming more widespread on the roads. In order to be able to increase both the range and the performance of such electric or hybrid vehicles, the aim is to keep a traction battery of such an electric or hybrid vehicle in an optimum temperature window for this traction battery, for which temperature control devices, in particular cooling devices, are used in a known manner. In order to achieve particularly efficient cooling, so-called immersion cooling is also used, in which a dielectric, i.e., electrically non-conductive, coolant flows around individual battery cells of the traction battery.

Such a battery cooling system for cooling a traction battery in particular also includes an expansion tank in which air is stored as an expansion cushion for a temperature-related change in volume of the coolant. An increase in temperature causes the coolant to expand, which could lead to a high pressure load in the expansion tank and possibly damage it if the resulting excess pressure cannot escape and should therefore be avoided. For this reason, such expansion tanks usually have a connection to the environment in order to be able to reduce a temperature-related pressure difference by blowing air into the environment if necessary. When the coolant cools down, it contracts, creating a vacuum in the expansion tank, which leads to fresh air being drawn in from the environment. The term “fresh air” can/should be understood as ambient air. In order to prevent or at least reduce the undesirable introduction of moisture into the coolant, so-called dryer cartridges are provided, in which a drying agent is arranged, through which the fresh air drawn in from the environment flows during the intake process, absorbing moisture and drying the fresh air drawn in.

A particular disadvantage of such expansion tanks is the comparatively difficult installation of a pressure relief valve or a vacuum valve in a wall of a tank housing of the expansion tank.

### SUMMARY

The present invention therefore deals with the problem of providing an improved or at least an alternative embodiment for an expansion tank, by means of which the disadvantages known from the prior art can be overcome.

According to the invention, this problem is solved by the subject matter of the independent claim(s). Advantageous embodiments are the subject matter of the dependent claim(s).

The present invention is based on the general idea of not arranging a pressure relief valve or a vacuum valve in a wall of a tank housing of an expansion tank for air in a battery cooling system, as has been customary up to now, but of integrating these valves in two lids which are only attached to the tank housing of the expansion tank in the assembled state, which considerably simplifies the assembly of the valves. The expansion tank is used to buffer a volume of air due to a temperature-related change in the volume of a cooling medium, in particular oil. The expansion tank according to the invention, in particular for air, for a battery cooling system has the aforementioned tank housing with a first lid with a threaded nipple and a second lid with a dryer cartridge which can be screwed onto the threaded nipple of the first lid, wherein the vacuum valve is arranged in the first lid, via which fresh air can be sucked into the expansion tank from the environment via the dryer cartridge and the threaded nipple, which can be hollow, when there is a vacuum in the expansion tank. The pressure relief valve is located in the second lid, via which air can be blown out of the expansion tank into the environment if there is excess pressure in the expansion tank. Of course, an activated carbon filter can also be provided here such that the air blown out via the pressure relief valve when there is excess pressure in the tank housing can still flow through the activated carbon filter and be cleaned of hydrocarbons there. A drying agent, in particular a molecular sieve such as zeolite, is arranged in the dryer cartridge. The arrangement of the vacuum valve in the first lid and the pressure relief valve in the second lid means that they are relatively easy to install even before the two lids are fitted to the tank housing. In particular, this eliminates the need for installation on an inner wall of the tank housing that is very difficult to access. This can also significantly simplify the replacement of such a valve in the event of maintenance or repair.

The first lid and/or the second lid is/are made of metal, in particular aluminum. The use of aluminum enables a weight-optimized and robust design. Aluminum can also be easily machined, for example drilled, making it particularly easy to attach the vacuum valve, for example in a bore provided with an internal thread.

In an advantageous further development of the invention, the tank housing is made of metal, in particular aluminum. The tank housing can be designed as an extruded aluminum profile or as a deep-drawn part made of aluminum. For example, the tank housing can be tubular, which is ideal for an extrusion process. A deep-drawing process is also suitable for the cost-effective and high-quality production of the tank housing, wherein deep-drawing offers further shaping possibilities.

In another particularly preferred embodiment of the expansion tank, the tank housing is made of plastic, in particular polyoxymethylene (POM). POM is a semi-crystalline thermoplastic with high mechanical strength and rigidity and also with high wear resistance and low moisture absorption, which is particularly advantageous when used for the expansion tank according to the invention, since in this case water retention or moisture absorption increases the electrical conductivity of a dielectric coolant. In order to further increase the mechanical strength and also the wear resistance, the plastic can have glass fibers, in particular 25% glass fibers, and in particular be designed as POM GF-25. The tank housing can also be designed as a plastic injection-molded part. The design as a plastic injection-molded part offers the great advantage of being able to manufacture the tank housing and thus also the expansion tank not only to a high quality, but also cost-effectively.

Advantageously, the dryer cartridge has a molecular sieve, in particular zeolite. The zeolite can be spherical, for example, and absorb moisture without any further energy input. This results in an exothermic reaction.

In another advantageous embodiment of the expansion tank, the vacuum valve opens at a negative pressure p₁ of −0.3 bar>p₁≥−0.5 bar, wherein the pressure relief pressure valve can open at a positive pressure p₂ of 0.4 bar≤p₂≤1.0 bar. These underpressures/overpressures allow a certain amount of overpressure/underpressure to be tolerated in the tank housing, which can reduce the air exchange cycles and extend the service life of the dryer cartridge. In general, without such valves, fresh air would be constantly drawn in from the environment or air would be expelled into the environment, which would greatly reduce the service life of the dryer cartridge and an HC absorber. The following applies: The higher or lower the opening pressure, the fewer replacement cycles take place.

The first lid and/or the second lid is/are particularly preferably sealed against the tank housing via a seal made of AEM (ethylene acrylate rubber) or a seal made of HNBR (hydrogenated nitrile rubber). It can also be used for a wide variety of materials. Acrylate-ethylene rubber (AEM) is a polymer made from ethylene methyl acrylate and a proportion of monomer with carboxylic acid groups. AEM is heat-resistant and resistant to chemicals and oil. HNBR has high media resistance, abrasion resistance, and good mechanical properties. As a result, both plastics are predestined for use as seals in the expansion tank according to the invention.

The present invention is further based on the general idea of equipping a battery cooling system with an expansion tank described in the previous paragraphs and thereby transferring the advantages described with respect to the expansion tank to the battery cooling system. Specifically, the advantages of a battery cooling system equipped with the expansion tank according to the invention lie in its cost-effective and simple manufacture, as pre-assembly of the two valves on the respective lid is significantly easier. When the dryer cartridge needs to be replaced at regular intervals, it can simply be unscrewed from the first lid and then a new one screwed back on.

Further important features and advantages of the invention are apparent from the sub-claims, from the drawings, and from the associated description of the figures with reference to the drawings.

It is understood that the features mentioned above and those to be explained below can be used not only in the combination indicated in each case, but also in other combinations or on their own, without departing from the scope of the present invention. The above-mentioned components of a superordinate unit, such as a device, an apparatus, or an arrangement, which are designated separately, can form separate parts or components of this unit or be integral areas or sections of this unit, even if this is shown differently in the drawing.

Preferred embodiments of the invention are shown in the drawings and are explained in more detail in the following description, with identical reference signs referring to identical or similar or functionally identical components.

### BRIEF DESCRIPTION OF THE DRAWINGS

It shows, schematically in each case:

FIG. 1 shows a sectional view of an expansion tank of a battery cooling system according to the invention,

FIG. 2 shows a detailed representation A from FIG. 1,

FIG. 3 shows a detailed representation B from FIG. 1,

FIG. 4 shows a sectional view of a pressure relief valve.

### DETAILED DESCRIPTION

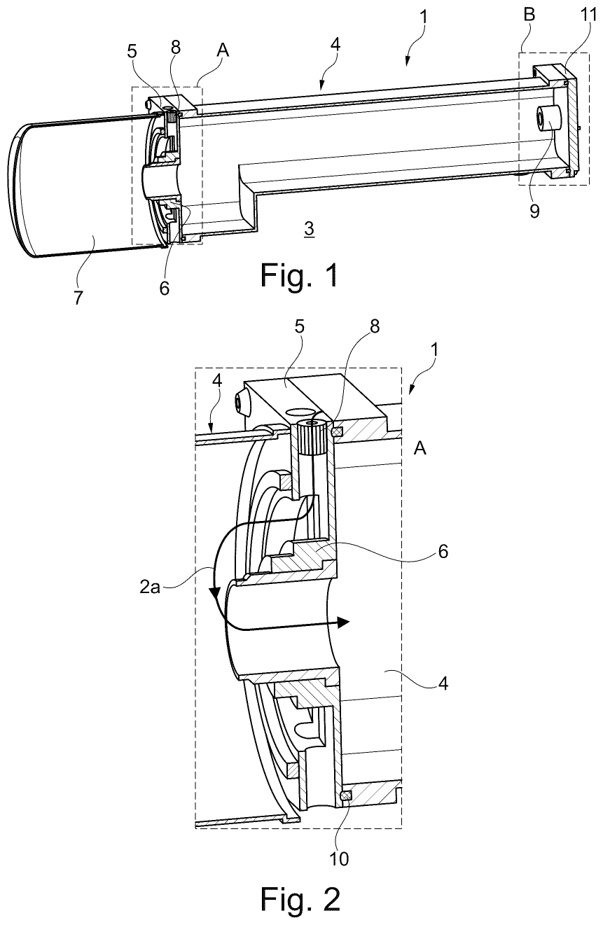

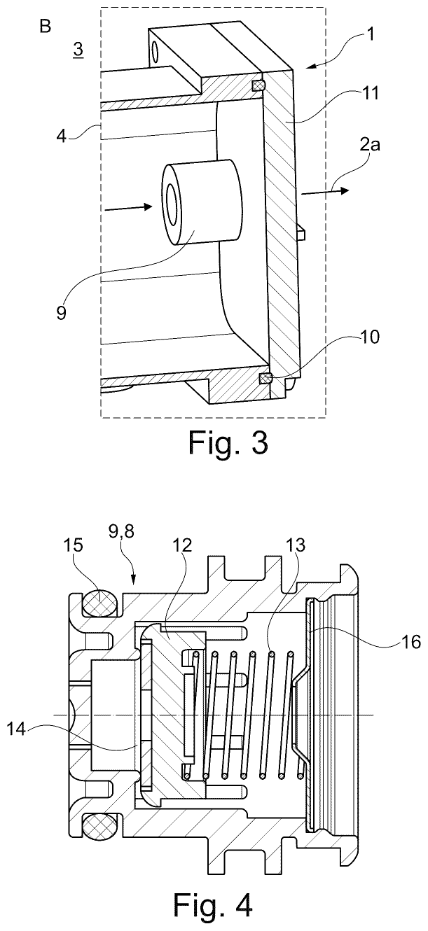

According to FIGS. 1 to 3, an expansion tank 1 for air 2 of a battery cooling system 3 according to the invention has a tank housing 4 made of plastic with a first lid 5 with a threaded nipple 6 and a second lid 11. A dryer cartridge 7 is also provided, which is screwed onto the threaded nipple 6 of the first lid 5. A vacuum valve 8 is arranged in the first lid 5, via which fresh air 2a from the environment enters the expansion tank 1 via the dryer cartridge 7 and the threaded nipple 6 when there is a vacuum in the expansion tank 1. This allows the fresh air 2a drawn in to be dried.

A pressure relief valve 9 is arranged in the second lid 11 (see also FIG. 4), via which air 2 can be blown out of the expansion tank 1 into the environment in the event of excess pressure in the expansion tank 1 or its tank housing 4.

The dryer cartridge 7 can be replaced by simply unscrewing it from or screwing it onto the threaded nipple 6. The dryer cartridge 7 can have a molecular sieve, in particular zeolite, or another drying agent.

By integrating the two valves 8, 9 in the respective lid 5, 11, it is possible to dispense with the difficult and therefore expensive installation of the valves 8, 9 in a wall of the tank housing 4 of the expansion tank 1. This allows the tank housing 4 to be designed very simply, for example as a tube. The arrangement of the vacuum valve 8 in the first lid 5 and the pressure relief valve 9 in the second lid 11 can also significantly simplify the replacement of such a valve 8, 9 in the event of maintenance or repair, as the valves 8, 9 are significantly easier to access when the lid 5, 11 is removed from the tank housing 4. The expansion tank 1 is used to buffer a volume of air due to a temperature-related change in the volume of a cooling medium, in particular oil.

The first lid 5 and/or the second lid 11 can be made of metal, in particular aluminum, whereby the use of aluminum enables a weight-optimized and at the same time robust design. Aluminum also makes it possible to produce a stable threaded nipple 6, which can be used to reliably secure the dryer cartridge 7. Of course, it is also conceivable that the lids 5, 11 could be made of plastic, in particular as an injection-molded plastic part.

The tank housing 4 can also be made of metal, in particular aluminum, in which case the tank housing 4 can be designed as an extruded aluminum profile or as a deep-drawn aluminum part. This enables high-quality and cost-effective production. A deep-drawing process is also suitable for manufacturing the tank housing 4.

The lids 5, 11 can be attached to the tank housing 4 by gluing or screwing, whereby screwing in particular enables especially easy maintenance or repair.

Like the lids 5, 11, the tank housing 4 can be made of plastic, in particular of polyoxymethylene, (POM). POM has a high mechanical strength and rigidity and also a high wear resistance and low moisture absorption, which is particularly advantageous when used for the expansion tank 1 according to the invention, since in this case water retention or moisture absorption increases the electrical conductivity of a dielectric coolant. Polyketones are also suitable for this purpose. Glass fibers, in particular 25% glass fibers, can be embedded in the plastic matrix to increase strength and/or wear resistance. The tank housing 4 can also be designed as a plastic injection-molded part, which offers the great advantage of high-quality and cost-effective production and enables shapes that cannot be achieved by extrusion molding, for example.

A molecular sieve, in particular zeolite, can be arranged in the dryer cartridge 7 as a drying agent.

The vacuum valve 8 can open at a negative pressure p₁ of −0.3 bar>p₁≥−0.5 bar, while the pressure relief valve 9 can open at a positive pressure p₂ of 0.4 bar≤p₂≤1.0 bar. These underpressures/overpressures allow a certain overpressure/underpressure to be tolerated in the tank housing, which can reduce the air exchange cycles and extend the service life of the dryer cartridge 7.

In order to be able to reliably seal an interior of the tank housing 4, the first lid 5 and/or the second lid 11 is/are sealed against the tank housing 4 via a seal 10 made of AEM (ethylene acrylate rubber) or HNBR (hydrogenated nitrile rubber). AEM is resistant to heat, chemicals, and oil. HNBR has high media resistance, abrasion resistance, and good mechanical properties.

The pressure relief valve 9 shown in FIG. 4 has a valve body 12 that is preloaded by means of a spring 13 and rests tightly on an associated valve seat 14 to close the pressure relief valve 9. The pressure relief valve 9 is sealed against the second lid 7 by means of an O-ring seal 15. It is of course clear that the pressure relief valve 9 shown in FIG. 4 can also be used as a vacuum valve 8 with the same design, only in reverse. The pressure relief valve 9 or the vacuum valve 8 can also prevent an impermissible increase/decrease in pressure in the coolant circuit. A diaphragm 16 can also be arranged on the vacuum valve 8 or the pressure relief valve 9 to prevent the unwanted ingress of splash water.

The expansion tank 1 also allows the battery cooling system 3 to be manufactured cost-effectively, as it is simple, especially as pre-assembly of the two valves 8, 9 on the associated lid 5, 11 is much easier. To replace the dryer cartridge 7 at regular intervals, it can also simply be unscrewed from the first lid 5 and then a new one screwed back on.

1. An expansion tank for a battery cooling system, comprising:
a tank housing including:
a first lid with a threaded nipple; and
a second lid;
a dryer cartridge screwable onto the threaded nipple of the first lid;
a vacuum valve arranged in the first lid via which fresh air from an environment enters the expansion tank via the dryer cartridge when there is a vacuum in the expansion tank; and
a pressure relief valve arranged in the second lid via which air is released from the expansion tank into the environment when there is excess pressure in the expansion tank.

2. The expansion tank according to claim 1, wherein at least one of the first lid and the second lid are composed of metal.

3. The expansion tank according to claim 2, wherein the tank housing is composed of metal.

4. The expansion tank according to claim 3, wherein the tank housing is structured as an extruded aluminum profile.

5. The expansion tank according to claim 1, wherein the tank housing is composed of a plastic.

6. The expansion tank according to claim 5, wherein the plastic includes a plurality of glass fibers.

7. The expansion tank according to claim 1, wherein the dryer cartridge includes a molecular sieve.

8. The expansion tank according to claim 1, wherein the vacuum valve opens at an underpressure of −0.3 bar to −0.5 bar.

9. The expansion tank according to claim 1, wherein at least one of:
the first lid is sealed against the tank housing via a first seal composed of ethylene acrylate rubber (AEM); and
the second lid is sealed against the tank housing via a second seal composed of AEM.

10. A battery cooling system, comprising an expansion tank according to claim 1.

11. The expansion tank according to claim 1, wherein the first lid and the second lid are at least partially composed of aluminum.

12. The expansion tank according to claim 1, wherein the tank housing is at least partially composed of aluminum.

13. The expansion tank according to claim 3, wherein the tank housing is structured as a deep-drawn aluminum part.

14. The expansion tank according to claim 5, wherein the plastic is polyoxymethylene (POM).

15. The expansion tank according to claim 5, wherein the plastic is polyketone.

16. The expansion tank according to claim 6, wherein the plastic has a 25% glass fiber content.

17. The expansion tank according to claim 7, wherein the molecular sieve is zeolite.

18. The expansion tank according to claim 1, wherein the pressure relief valve opens at an overpressure of 0.4 bar to 1.0 bar.

19. The expansion tank according to claim 1, further comprising:
a first seal disposed between and sealingly contacting the tank housing and the first lid; and
a second seal disposed between and sealingly contacting the tank housing and the second lid.

20. The expansion tank according to claim 19, wherein the first seal and the second seal are cach at least partially composed of hydrogenated nitrile rubber (HNBR).
